(19) United States
(12) Patent Application Publication
(10) Pub. No.: US 2026/0046587 A1
(43) Pub. Date: Feb. 12, 2026

(54) SPATIAL ENHANCEMENT FOR USER-GENERATED CONTENT

(71) Applicant: DOLBY LABORATORIES LICENSING CORPORATION, San Francisco, CA (US)

(72) Inventors: Yuanxing MA, Beijing (CN); Zhiwei SHUANG, Beijing (CN); Yang LIU, Beijing (CN)

(73) Assignee: DOLBY LABORATORIES LICENSING CORPORATION, San Francisco, CA (US)

(21) Appl. No.: 19/100,457

(22) PCT Filed: Aug. 7, 2023
(86) PCT No.: PCT/US2023/071791

§ 371 Date: Jan. 31, 2025

Related U.S. Application Data
(60) Provisional application No. 63/430,247, filed on Dec. 5, 2022.
(60) Provisional application No. 63/496,820, filed on Apr. 18, 2023.

(30) Foreign Application Priority Data
Aug. 9, 2022 (WO) PCT/CN2022/111239

(51) Int. Cl. H04S 7/00; H04S 3/00

(52) U.S. Cl. CPC H04S 7/304; H04S 3/008; H04S 2400/01; H04S 2400/11; H04S 2400/13; H04S 2400/15; H04S 2420/01

(57) ABSTRACT

Methods, systems, and media for enhancing audio content are provided. In some embodiments, a method for enhancing audio content involves receiving a multi-channel audio signal from a first audio capture device and a binaural audio signal from a second audio capture device. The method may further involve extracting one or more objects from the multi-channel audio signal. The method may further involve generating a spatial enhancement mask based on spatial information associated with the one or more objects. The method may further involve applying the spatial enhancement mask to the binaural audio signal to enhance spatial characteristics of the binaural audio signal to generate an enhanced binaural audio signal. The method may further involve generating output binaural audio signal based on the enhanced binaural audio signal.

### CROSS-REFERENCE TO RELATED APPLICATIONS

This application claims the benefit of priority from PCT/CN2022/111239 filed Aug. 9, 2022, U.S. Provisional Application Ser. No. 63/430,247, filed on Dec. 5, 2022, and U.S. Provisional Application Ser. No. 63/496,820, filed on Apr. 18, 2023, each of which is incorporated by reference herein in its entirety.

### TECHNICAL FIELD

This disclosure pertains to systems, methods, and media for spatial enhancement for user-generated content.

### BACKGROUND

Recently, user-generated content, such as user-captured video content, has proliferated. Such content may be shared directly between users, posted on social media sites or other content-sharing sites, or the like. Users may seek to generate immersive content, where a viewer of the user-generated content views user-captured video and audio with the audio content rendered in an immersive manner. However, rendering user-generated content with immersive audio is difficult.

### NOTATION AND NOMENCLATURE

Throughout this disclosure, including in the claims, the terms “speaker,” “loudspeaker” and “audio reproduction transducer” are used synonymously to denote any sound-emitting transducer (or set of transducers). A typical set of headphones includes two speakers. A speaker may be implemented to include multiple transducers (e.g., a woofer and a tweeter), which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

### SUMMARY

In some embodiments, a method for enhancing audio content involves receiving a multi-channel audio signal from a first audio capture device and a binaural audio signal from a second audio capture device. The method further involves extracting one or more objects from the multi-channel audio signal. The method further involves generating a spatial enhancement mask based on spatial information associated with the one or more objects. The method further involves applying the spatial enhancement mask to the binaural audio signal to enhance spatial characteristics of the binaural audio signal to generate an enhanced binaural audio signal. The method further involves generating output binaural audio signal based on the enhanced binaural audio signal.

In some examples, the method further involves processing a residue associated with the multi-channel audio signal, wherein the residue comprises portions of the multi-channel audio signal other than those associated with the one or more objects. In some examples, processing the residue comprises emphasizing portions of the residue originating from at least one spatial direction. In some examples, the at least one spatial direction comprises an up-and-down direction. In some examples, the method further involves mixing the processed residue with the enhanced binaural audio signal prior to generating the output binaural audio signal.

In some examples, generating the spatial enhancement mask comprises generating gains to be applied to the one or more objects from the multi-channel audio signal based on spatial directions associated with the one or more objects.

In some examples, the method further involves applying at least one of: a) level adjustments; or b) timbre adjustments to the binaural audio signal. In some examples, the level adjustments are configured to boost a level associated with less prominent objects of the one or more objects compared to more prominent objects of the one or more objects. In some examples, the timbre adjustments are configured to account for a head-related transfer function that provides binaural cues to a listener.

In some examples, the method further involves storing the generated output binaural audio signal in connection with spatial metadata associated with the extracted one or more objects. In some examples, the spatial metadata is usable by a playback device to render the generated output binaural audio signal based on head tracking information.

In some examples, extracting the one or more objects comprises at least one of: using a trained machine learning model; or using a correlation-based analysis.

In some examples, the one or more objects comprise at least one speech object and at least one non-speech object.

In some examples, at least one of the first audio capture device or the second audio capture device is a mobile phone.

In some examples, at least one of the first audio capture device or the second audio capture device is a wearable device.

In some examples, the multi-channel audio signal is captured in connection with video content captured by the first audio capture device.

In some examples, the method further involves transforming the multi-channel audio signal and the binaural audio signal from a time domain representation to a frequency domain representation prior to extracting the one or more objects from the multi-channel audio signal.

In some examples, generating the output binaural audio signal based on the enhanced binaural audio signal comprises transforming the enhanced binaural audio signal from a frequency domain representation to a time domain representation.

In accordance with some embodiments, a method of presenting audio content may involve receiving an enhanced binaural audio signal and spatial metadata to be played back by a pair of headphones or earbuds, wherein the enhanced binaural audio signal was generated based on audio content captured by two different audio capture devices, and wherein the spatial metadata was generated based on audio objects extracted in audio content captured by at least one of the two different audio capture devices. The method may involve obtaining head orientation information of a wearer of the headphones or earbuds. The method may involve rendering the enhanced binaural audio signal based at least in part on the head orientation information and the spatial metadata. The method may involve causing the rendered enhanced binaural audio signal to be presented via the headphones or the earbuds.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via an apparatus. For example, one or more devices may be capable of performing, at least in part, the methods disclosed herein. In some implementations, an apparatus is, or includes, an audio processing system having an interface system and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating use of a pair of earbuds and a mobile device to generate spatially enhanced user-generated content in accordance with some embodiments.

FIG. 2A is a schematic block diagram of an example system for generating spatially enhanced user-generated content in accordance with some embodiments.

FIG. 2B is a schematic block diagram of another example system for generating spatially enhanced user-generated content in accordance with some embodiments.

FIG. 3 is a schematic block diagram of a system for generating spatial analysis information in accordance with some embodiments.

FIG. 4 is a schematic block diagram of a system for applying a spatial enhancement mask in accordance with some embodiments.

FIG. 5 is a schematic block diagram of a system for applying a spatial enhancement mask in conjunction with head tracking information in accordance with some embodiments.

FIG. 6A is a schematic block diagram of an example system for mixing audio signals from two user devices in accordance with some embodiments.

FIG. 6B is a schematic block diagram of another example system for mixing audio signals from two user devices in accordance with some embodiments.

FIG. 7 is a flowchart of an example process for generating a spatially-enhanced binaural output audio signal in accordance withs some embodiments.

FIG. 8 is a flowchart of an example process for rendering a binaural audio signal based on head tracking information in accordance with some embodiments.

FIG. 9 is a flowchart of an example process for generating a spatially-enhanced binaural output audio signal in accordance with some embodiments.

FIG. 10 shows a block diagram that illustrates examples of components of an apparatus capable of implementing various aspects of this disclosure.

Like reference numbers and designations in the various drawings indicate like elements.

### DETAILED DESCRIPTION OF EMBODIMENTS

Recently, user-generated content, such as user-captured video content, has proliferated. Such content may be shared directly between users, posted on social media sites or other content-sharing sites, or the like. Users may seek to generate immersive content, where a viewer of the user-generated content views user-captured video and audio with the audio content rendered in an immersive manner. However, it is difficult to generate such immersive user-generated audio content.

Disclosed herein are systems, methods, and media for generating immersive user-generated audio content. In some embodiments, multi-channel audio content may be obtained with a first audio capture device, such as a mobile phone, a tablet computer, smart glasses, etc. The multi-channel audio content may be obtained in connection with corresponding video content obtained using one or more cameras of the first audio capture device (e.g., a front-facing and/or a rear-facing camera of the device). Concurrently, binaural audio content may be captured by a second audio capture device. The second audio capture device may include, e.g., earbuds paired with the first audio capture device. For example, the binaural audio content may be obtained via microphones disposed in or on the earbuds. In some embodiments, the binaural audio signal obtained by the second audio capture device may be enhanced based on one or more audio objects identified in the multi-channel audio content. For example, the one or more audio objects may include, e.g., a bird chirping, thunder, an airplane flying overhead, etc. Portions of the binaural audio signal captured by the second audio capture device corresponding to the one or more audio objects may be enhanced based on spatial metadata and other information generated based on the one or more audio objects identified in the multi-channel audio content. Enhancement of the binaural audio signal may cause the one or more audio objects to be boosted in level such that the audio objects are perceived more clearly and/or robustly. In some embodiments, timbre of portions of the binaural audio signal may be adjusted to emphasize binaural cues associated with the one or more audio objects, thereby causing spatial locations of the audio objects to be perceived more strongly. An enhanced binaural audio signal may be generated by enhancing portions of the binaural audio signal from the second audio capture device corresponding to one or more audio objects identified based on a multi-channel audio content obtained via a first audio capture device. The enhanced binaural audio signal may then be stored, transmitted to a rendering device, or the like.

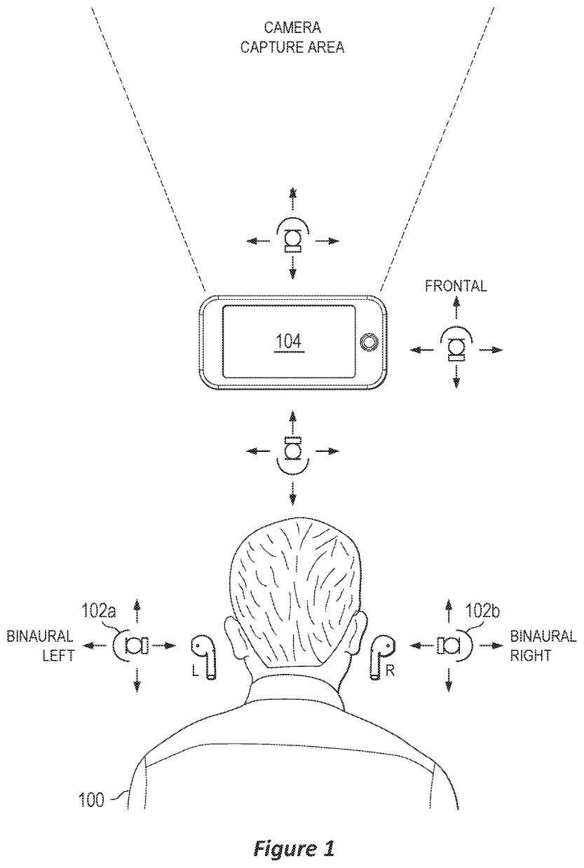

FIG. 1 illustrates an example system for recording user-generated content from two devices in accordance with some embodiments. As illustrated, a user 100 may be wearing earbuds 102a and 102b. Each earbud may be equipped with a microphone disposed in or on the earbud, thereby allowing earbuds 102a and 102b to record binaural left and binaural right audio signals, respectively. Concurrently with recording audio content via earbuds 102a and 102b, user 100 may record audio and video content using mobile device 104. The video content may be recorded using a front-facing camera and/or a rear-facing camera. The audio content may be multi-channel audio content having, e.g., two, three, four, etc. channels of audio content.

In some implementations, spatially enhanced binaural audio content may be generated by extracting, from a multi-channel audio signal (e.g., obtained from a mobile device, such as a mobile phone or tablet computer), one or more audio objects present in the multi-channel audio signal. Spatial information analysis may be performed on the identified one or more audio objects to identify, e.g., spatial information associated with spatial positions at which the one or more audio objects are to be perceived when rendered. A spatial enhancement mask may then be generated based on the spatial information, e.g., to enhance spatial perception of the one or more audio objects. The spatial enhancement mask may then be applied to a representation of a binaural audio signal obtained from a second device, such as earbuds worn by the user. In other words, the spatial enhancements determined based on the audio objects identified in the multi-channel audio signal from the first device may be applied to the binaural audio signal obtained using the second device. Note that the multi-channel audio signal and the binaural audio signal may both be transformed from a time-domain to a frequency domain prior to any processing and/or analysis. In some such embodiments, the enhanced binaural audio signal (e.g., the binaural audio signal after the spatial enhancement mask is applied) may be transformed back to the time domain to generate an output enhanced binaural audio signal.

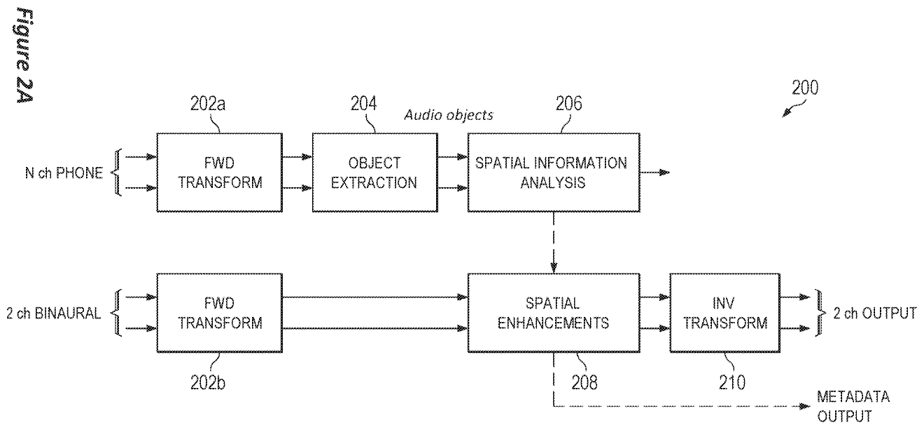

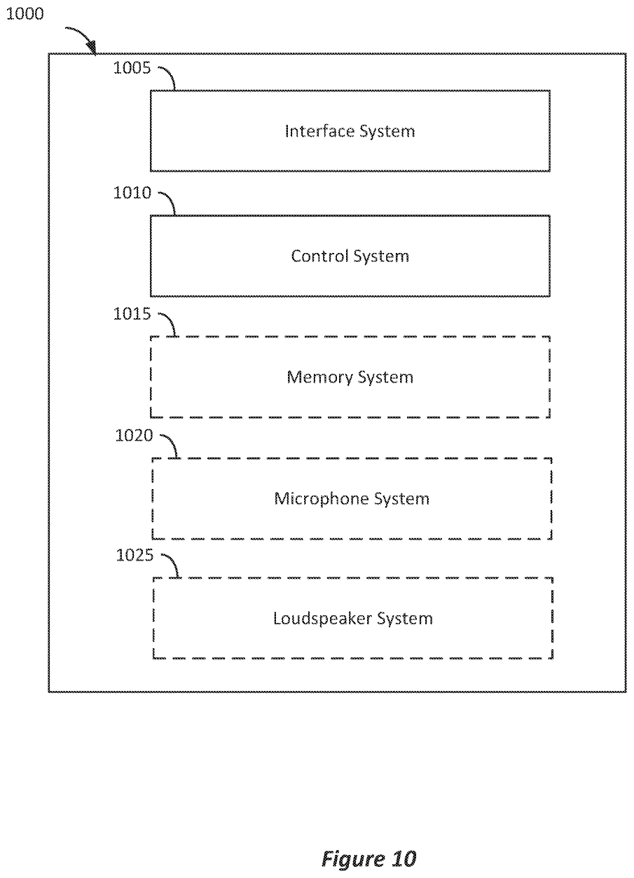

FIGS. 2A, 2B, 3, 4, 5, 6A, and 6B depict example systems for enhancing binaural audio content. It should be noted that components of each system may each be implemented by one or more processors and/or control systems. An example of such a control system is shown in and described below in connection with FIG. 10 (e.g., control system 1010). Moreover, in some cases, a given system may be implemented by processors and/or control systems of one or more devices, such as a device that captures the user-generated content, and a device that renders the user-generated content.

FIG. 2A is a block diagram of an example system 200 configured for generating spatially-enhanced binaural audio content in accordance with some embodiments. Components of system 200 may be implemented as one or more control systems, such as control system 1010 shown in and described below in connection with FIG. 10. As illustrated, a forward transform block 202a may receive multi-channel audio content (e.g., from a mobile phone) and transform the multi-channel audio content from the time domain to the frequency domain. Forward transform block 202b may similarly receive binaural audio content (e.g., form a pair of earbuds) and transform the multi-channel audio content from the time domain to the frequency domain. Transformation to the frequency domain may be implemented using, e.g., a short-time Fourier transform, or the like.

Object extraction block 204 may identify one or more audio objects in the frequency-domain representation of the multi-channel audio signal. In some embodiments, object identification may be implemented using a trained machine learning algorithm. The trained machine learning algorithm may have a recurrent neural network (RNN) or convolutional neural network (CNN) architecture. The audio objects may be identified based on targets that identify, e.g., height information, that may be used to cluster and identify audio objects such as speech, birds chirping, thunder, rain, etc. In some embodiments, object identification may be implemented using a correlation-based algorithm. For example, the multi-channel audio signal may be divided into multiple (e.g., four, eight, sixteen, etc.) frequency bands, and a correlation may be determined for each frequency band across all of the input channels. Portions of frequency bands with a relatively high correlation across all channels may be considered an audio object.

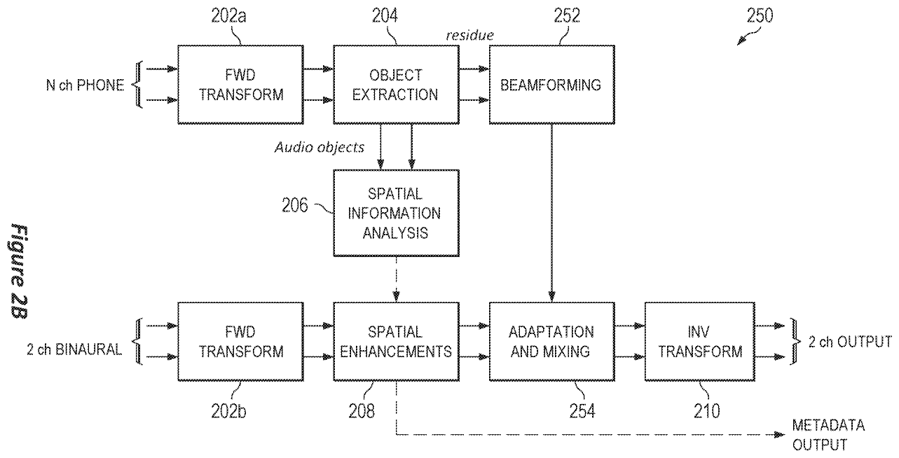

Spatial information analysis block 206 may be configured to determine a spatial enhancement mask based on the identified audio objects. The spatial enhancement mask may be determined using beamforming techniques. For example, the beamforming techniques may identify regions to be emphasized based on the identified audio objects. Spatial information analysis block 206 may then determine gains for different frequency bands based on the beamforming output. An example implementation of spatial information analysis block 206 is shown in and described below in connection with FIG. 3. Note that, in some embodiments, spatial information analysis block 206 may additionally generate spatial metadata. The spatial metadata may be used by a rendering device to render the binaural audio signal based on head tracking data.

Spatial enhancement block 208 may be configured to apply the spatial enhancement mask generated by spatial information analysis block 206 to the binaural audio signal. The spatial enhancement mask may be applied in the frequency domain, e.g., by multiplying a signal representing the spatial enhancement mask in the frequency domain by the frequency domain representation of the binaural audio signal. By applying the spatial enhancement mask, the levels and/or timbre of the binaural audio signal may be adjusted based on regions to be emphasized, which in turn may be based on the identified audio objects.

Inverse transform 210 may transform the enhanced binaural audio signal in the frequency domain to the time domain, thereby generating an output enhanced binaural audio signal. In some embodiments, an inverse STFT may be used. The output enhanced binaural audio signal may be stored on the user device (e.g., a mobile phone that captured the multi-channel audio signal), transmitted to a server for storage and later playback, transmitted to another user device (e.g., in a chat message, via a wireless connection pairing the two user devices, etc.), or the like.

A remaining portion of a multi-channel audio signal other than the portion corresponding to one or more identified audio objects is generally referred to herein as a “residue.” In some embodiments, the residue may be processed to, for example, emphasize portions of the residue that correspond to audio signals, an audio signal, or portions of an audio signal originating in one or more directions of interest. For example, in some embodiments, portions of the residue from an elevated spatial direction (e.g., perceived as above a listener's head) may be emphasized, e.g., to emphasize sounds such as an overhead aircraft. In some embodiments, because such audio objects may not have a clear frequency pattern, they may not have been extracted as audio objects, and accordingly, may be present in the residue rather than in the set of identified audio objects. However, by emphasizing portions of the residue, an audio object that was not identified as such may be emphasized in the binaural audio signal. In some implementations, emphasis of the residue may be implemented using beamforming techniques. For example, a beamformed signal may be generated to emphasize signal originating from one or more direction of interest in the residue signal. The beamformed signal may then be mixed with a spatially enhanced binaural signal to generate an output audio signal, which may be in the frequency domain.

FIG. 2B depicts an example system 250 configured for generating spatially enhanced binaural audio signals in accordance with some implementations. Components of system 250 may be implemented as one or more control systems or processors. An example of such a control system is control system 1010 of FIG. 10. The components of example system 250 in general include the components of example system 200 shown in and described above in connection with FIG. 2A. However, system 250 includes a beamforming component 252 and an adaptation and mixing component 254. As described above, beamforming component 252 may take, as an input, a residue portion of the multi-channel audio signal that corresponds to the portion of the multi-channel audio signal other than the identified audio objects. Beamforming components 252 may emphasize portions of the residue signal originating from one or more spatial locations of interest, such as from elevated or high channels of the multi-channel audio signal. The enhanced residue signal may then be mixed with the output of spatial enhancement block 208 (described above in connection with FIG. 2A). Adaptation and mixing block 254 may generate, as an output, a frequency domain representation of the enhanced binaural audio signal that includes the enhanced residue signal mixed with the enhanced binaural audio signal. The mixed signal may then be converted to the time domain by inverse transform block 210 to generate the output enhanced audio signal.

In some embodiments, spatial information analysis may be performed on one or more audio objects identified in a multi-channel audio signal (e.g., obtained from a mobile phone, a tablet computer, smart glasses, etc.). In some embodiments, beamforming techniques may be used to enhanced signals originating from particular directions, e.g., from an elevated spatial position along the Z axis, or the like. In such embodiments, a beamformer may reject sounds originating from the horizontal plane. In some embodiments, beamforming techniques may implement a dipole beamformer pointing upwards along the Z axis to emphasize audio signal originating from along the Z axis rather than audio signal in the horizontal plane. In some embodiments, the beamforming techniques may be utilized to estimate gains. Gains may be determined for each frame (generally referred to herein as frame index m) and frequency band (generally referred to herein as band index k). In some embodiments, gains may be utilized to generate a spatial enhancement mask by combining a spatial analysis result (which emphasizes signal from particular spatial directions) with identified object analysis.

FIG. 3 is an example implementation of a spatial information analysis block 300 in accordance with some embodiments. In some embodiments, spatial information analysis block 300 may be an instance of spatial information analysis block 206, as shown in FIGS. 2A and 2B. Spatial information analysis block 300 may be utilized in system 200 and/or system 250 as shown in and described above in connection with FIGS. 2A and/or FIG. 2B, respectively. As illustrated, spatial information analysis block 300 includes a beamforming block 304 and an enhancement mask generation block 306.

As illustrated, beamforming block 304 may take, as input, a multi-channel signal having N channels. The multi-channel signal may correspond to the identified audio objects in the multi-channel audio signal obtained using a user device, as shown in and described above in connection with FIGS. 2A and 2B. In some embodiments, beamforming block 304 may be configured to estimate a gain for an audio frame m and a frequency band k. The gain may be determined based on a ratio of a power of a beamforming output for the frequency band k to a power of the beamforming input for the frequency band k, where the power is dependent on a spatial direction of the frame m of the multi-channel signal. For example, the gain, generally represented herein as [symbol] (m, k), may be determined by:

$$( m , k ) = \frac{{P}_{y} ( m , k )}{Σ {p}_{i} ( m , k )}$$

In the equation given above, P_{y}(m, k) represents the power of beamforming output y for frame m and frequency band k, and pᵢ(m, k) represents the power of beamforming input xᵢ for frame m and frequency band k.

The gains generated by beamforming block 304 may be provided to enhancement mask generation block 306. Enhancement mask generation block 306 may be configured to generate a spatial enhancement mask, generally referred to herein as M_{enhance}, for frame m and frequency band k. The spatial enhancement mask may be generated based on a combination of the gains applied based on spatial direction of the sound signals and the identified audio objects. The identified audio objects may be represented by M_{objects}(m, k). In one example, the spatial enhancement mask may be determined by:

$${M}_{e n h a n c e} ( m , k ) = {M}_{object} ( m , k ) * σ ( ( m , k ) )$$

In the equation given above, σ( ) represents an activation function applied to the gains.

In some embodiments, a spatial enhancement mask may be applied to the portion of the multi-channel audio signal corresponding to the identified one or more audio objects. The spatial enhancement mask may emphasize the spatial properties of the one or more audio objects, which may improve the immersive feeling when rendered on a playback device. Application of a spatial enhancement mask may adjust a level and/or a timbre of the audio objects. For example, level adjustment may boost a volume or energy level of one or more audio objects such that the one or more audio objects are perceived more clearly within the eventual enhanced binaural audio signal. As another example, timbre adjustment may adjust the one or more audio objects by adjusting binaural cues that indicate, when rendered, spatial locations of the one or more audio objects. For example, perceived height or elevation of different audio objects may be adjusted based on shoulder and/or pinna reflections associated with sound sources of different elevational angles.

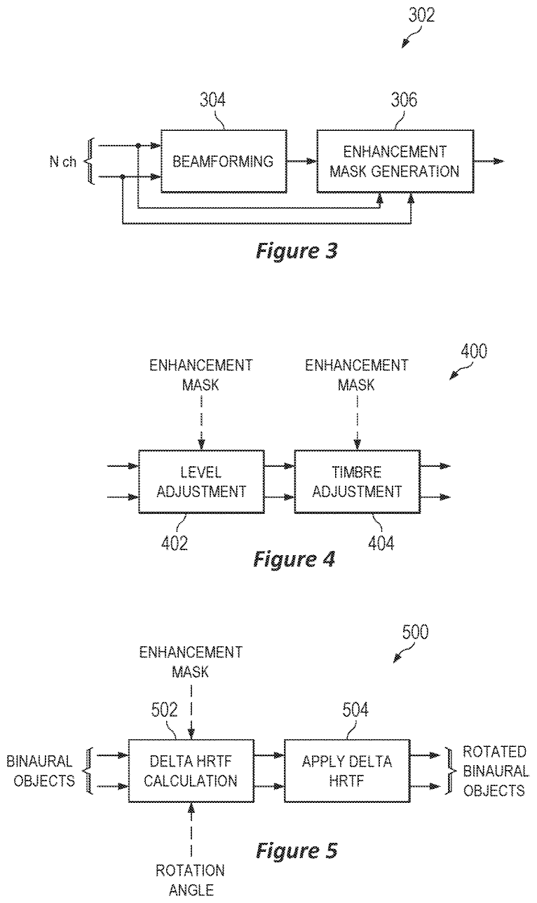

FIG. 4 is a block diagram of an example implementation of a spatial enhancement block 400 in accordance with some embodiments. In some embodiments, spatial enhancement block 400 may be an instance of spatial enhancement block 208, as shown in FIGS. 2A and 2B. Spatial enhancement block 400 includes a level adjustment block 402 and a timbre adjustment block 404. Each of level adjustment block 402 and timbre adjustment block 404 may take, as inputs, a spatial enhancement mask (e.g., generated by a spatial information analysis block, as shown in and described above in connection with FIG. 3). Level adjustment block 402 may boost a level or energy associated with one or more identified audio objects based on the spatial enhancement mask. Level adjustment may be performed on a per-frame and per-frequency band basis. Timbre adjustment block 404 may adjust the audio signal to adjust binaural cues, which may serve to emphasize the spatial location of each of the identified one or more audio objects. Timbre adjustment may be performed on a per-frame and per-frequency band basis.

In some embodiments, a spatial enhancement mask may be applied at a rendering device based on a head orientation of a user of the rendering device. Note that head orientation may be determined based on one or more sensors (e.g., one or more accelerometers, one or more gyroscopes, one or more magnetometers, etc.) of the rendering device and/or headphones or earbuds paired with the rendering device. In some embodiments, a head rotation angle may be determined based on data from the one or more sensors associated with the rendering device. A difference between the original location of a given audio object and the location accounting for head rotation may be determined, and the spatial enhancement mask may be applied based on the difference. Accordingly, audio objects may then be rendered at spatial locations that are more accurate with respect to the originally captured audio content by accounting for head orientation of the listener.

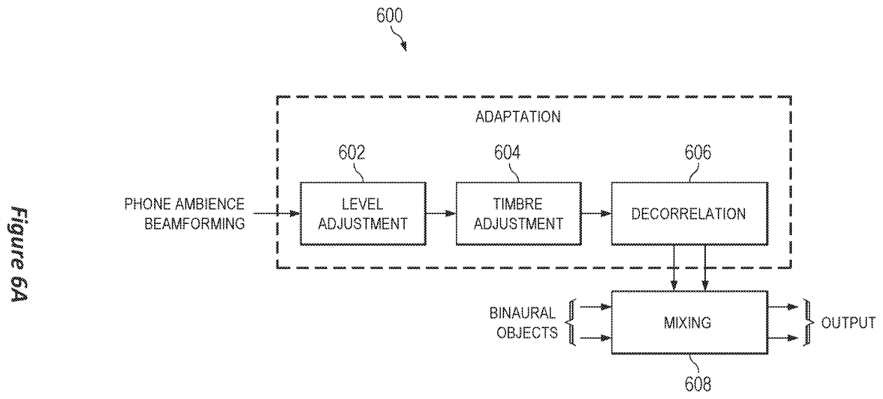

FIG. 5 illustrates an example implementation of a spatial enhancement block 500 that applies a spatial enhancement mask based on a head orientation of a listener. In some embodiments, spatial enhancement block 500 may be an instance of spatial enhancement block 208 as shown in FIGS. 2A and 2B. Note that spatial enhancement block 500 may be implemented on a rendering device. As illustrated, spatial enhancement block 500 may include a delta head-related transfer function (HRTF) block 502, and an apply delta HRTF block 504. Delta HRTF block 502 may take, as inputs, a binaural audio signal (e.g., as obtained by earbuds associated with a user-generated content capturing device), a spatial enhancement mask (e.g., as generated by a spatial information analysis block), and a rotation angle of a listener of the rendering device. The rotation angle may be determined based on one or more sensors associated with the rendering device (e.g., one or more sensors disposed in or on headphones or earbuds of the rendering device and/or paired with the rendering device). Delta HRTF block 502 may be configured to determine a difference between the original location of a given audio object and the location the object is to be rendered after accounting for the listener's head orientation. Apply delta HRTF block 504 may be configured to apply the spatial enhancement mask based on the difference between the original location of the object and the location accounting for the listener's head orientation. Note that because the spatial metadata is used to determine the enhancement mask, the spatial metadata may be implicitly passed to delta HRTF block 502. The output of apply delta HRTF block 504 may be rotated audio objects, e.g., rotated based on the listener's current head orientation.

As described above, an output of a beamforming block that emphasizes portions of a residue signal may be adjusted and mixed with an enhanced binaural signal. Adjustment and mixing may serve to equalize the levels and timbres of the multi-channel audio signal obtained via a first device (e.g., a mobile phone, a tablet computer, smart glasses, etc.) with a binaural audio signal obtained via a second device (e.g., earbuds). In some embodiments, adjustment may be performed by an adaptation block that is configured to adjust levels and/or timbres, and decorrelating the residue signal. Generation of a decorrelated residue signal ensures that the signals added to the enhanced binaural signal are not correlated with each other. In some embodiments, the residue signal may be decorrelated into two signals, which may then be mixed with the two signals of the enhanced binaural signal. Decorrelation may be performed using time delay between the two channels.

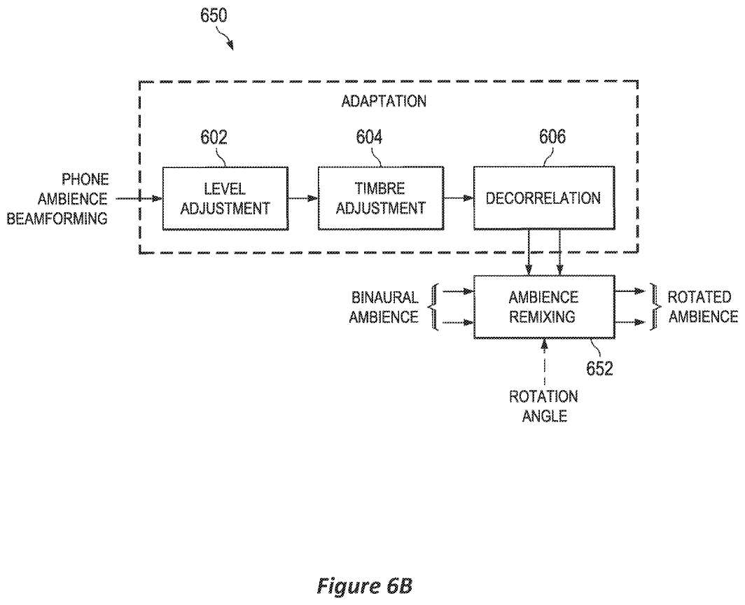

FIG. 6A is a block diagram of an example adaptation and mixing block 600 in accordance with some embodiments. In some embodiments, adaptation and mixing block 600 may be an instance of adaptation and mixing block 254, as shown in FIG. 2B. As illustrated, adaptation may be performed by level adjustment block 602, timbre adjustment block 604, and decorrelation block 606. Adaptation may be performed on a residue signal that is an output of a beamforming block configured to emphasize portions of a residue signal. As discussed above, the residue signal may correspond to portions of a multi-channel audio signal other than the signal associated with one or more identified audio objects. Level adjustment block 602 may be configured to adjust a level of the residue signal such that the level of the residue signal (captured by a first device) matches a level of the binaural audio signal (captured by a second device). Timbre adjustment block 604 may be configured to adjust a timbre of the residue signal such that the timbre of the residue signal matches a timbre of the binaural audio signal. Decorrelation block 606 may be configured to take the multi-channel residue signal and generate two decorrelated audio signals.

Mixing block 608 may be configured to take, as an input, the enhanced binaural signal and the decorrelated audio signals associated with the residue signal. Mixing block 608 may be configured to combine the enhanced binaural signal and the decorrelated audio signals to generate an output enhanced binaural audio signal. Note that, in some embodiments, the output generated by mixing block 608 may be in the frequency domain, and the output may be transformed to the time domain to generate the output enhanced binaural audio signal.

In some embodiments, adaptation and mixing may be performed on a rendering device. In some such implementations, mixing may be performed based on the head orientation of a user of the rendering device. FIG. 6B illustrates an example adaptation and mixing block 650 in which portions may be executed by a rendering device such that mixing is performed based on a head orientation of a listener of the rendering device. In some embodiments, adaptation and mixing block 650 may be an instance of adaptation and mixing block 254 shown in FIG. 2B. The adaptation portion of adaptation and mixing block 650 is similar to the adaptation portion of adaptation and mixing block 600 (shown in and discussed above in connection with FIG. 6A). However, adaptation and mixing block 650 includes an ambience remixing block 656 configured to take the decorrelated residue signals from decorrelation block 606 as input and mix the decorrelated residue signals with the binaural audio signals based on a rotation angle of the listener's head. Ambience remixing may serve to, e.g., boost the level of an audio object to be rendered as perceived above the user's head (e.g., a bird chirping, an airplane flying, etc.) when the user rotates their head to look up, thereby increasing the perception of immersiveness. For example, an audio object may be boosted by 1 dB, 2 dB, 3 dB, 5 dB, or the like based on the listener's head orientation.

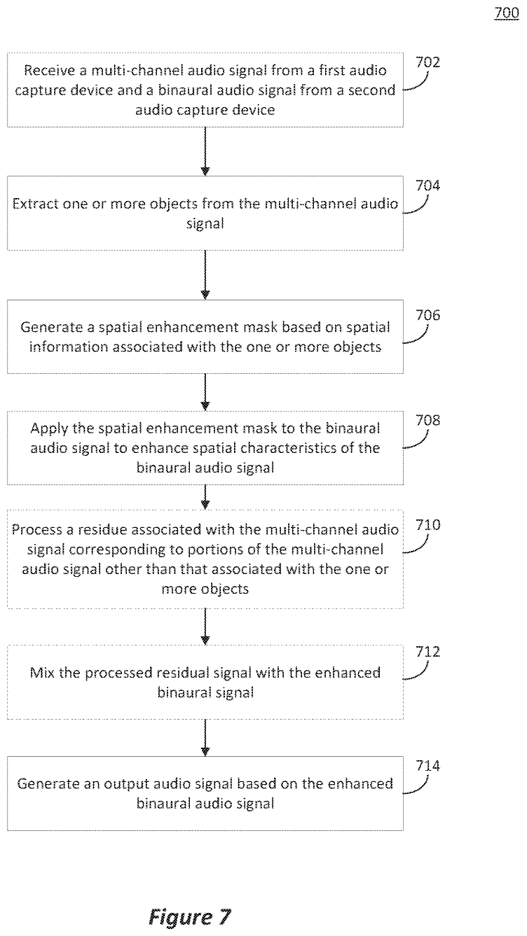

FIG. 7 is a flowchart of an example process 700 for generating an enhanced output audio signal based on audio content obtained from two different devices. In some embodiments, blocks of process 700 may be executed on a device that captures user-generated content (e.g., a mobile device, such as a mobile phone or a tablet computer), a desktop computer, a server device that stores and/or provides user-generated content, or the like. In some embodiments, blocks of process 700 may be executed by one or more processors or control systems of such a device, such as control system 1010 of FIG. 10. In some embodiments, blocks of process 700 may be performed in an order other than what is shown in FIG. 7. In some implementations, two or more blocks of process 700 may be performed substantially in parallel. In some implementations, one or more blocks of process 700 may be omitted.

Process 700 can begin at 702 by receiving a multi-channel audio signal from a first audio capture device and a binaural audio signal from a second audio capture device. As described above in connection with FIG. 1, the first audio capture device may be a mobile phone, a tablet computer, smart glasses, etc. The first audio capture device may concurrently capture video content associated with the multi-channel audio content. The second audio capture device may be, e.g., earbuds, paired with the first audio capture device.

At 704, process 700 can extract one or more audio objects from the multi-channel audio signal. Note that, in some embodiments prior to extracting the one or more audio objects, process 700 can transform a time-domain representation of the multi-channel audio signal to a frequency domain representation. In some embodiments, audio object identification may be performed using a trained machine learning model (e.g., a CNN, an RNN, etc.). Additionally or alternatively, in some embodiments, identification of the one or more audio objects may be performed using digital signal processing (DSP) techniques, such as correlation of the multi-channel audio signal across different frequency bands.

At 706, process 700 can generate a spatial enhancement mask based on spatial information associated with the one or more audio objects. For example, the spatial enhancement mask may be determined by applying beamforming techniques to emphasize portions of the multi-channel audio signal originating from one or more spatial directions. For example, the beamforming techniques may emphasize portions of the multi-channel audio signal originating from along the Z axis and may de-emphasize signal originating from the horizontal plane. Example techniques for generating a spatial enhancement mask are shown in and described above in connection with FIG. 3. Note that, in some embodiments, process 700 may additionally generate spatial metadata that may be used by a rendering device to render the enhanced binaural audio signal. For example, the spatial metadata may be used to render the enhanced binaural audio signal based on a head orientation of a listener of the rendering device.

At 708, process 700 can apply the spatial enhancement mask to the binaural audio signal to enhance spatial characteristics of the binaural audio signal. In other words, process 700 can utilize the audio objects identified in the multi-channel audio signal captured by the first audio capture device to emphasize or enhance portions of the binaural audio signal captured by the second audio capture device. Application of the spatial enhancement mask to the binaural audio signal may involve boosting the level of portions of the binaural audio signal (e.g., those corresponding to the identified audio objects) and/or modifying a timbre of portions of the binaural audio signal to emphasize binaural cues. Example techniques for applying a spatial enhancement mask are shown in and described above in connection with FIGS. 4 and 5.

Optionally, in some embodiments, process 700 can process a residue associated with the multi-channel audio signal corresponding to portions of the multi-channel audio signal other than that associated with the one or more audio objects at 710. For example, as described above in connection with FIG. 2B, process 700 can utilize beamforming techniques to determine and apply gains to the residue signal. Such gains may be applied to emphasize portions of the residue signal originating from directions of interest that were not identified as belonging to particular audio objects.

If, at 710, process 700 processed the residue associated with the multi-channel audio signal, at 712, process 700 can mix the processed residue signal with the enhanced binaural signal. Otherwise, block 712 can be omitted. For example, in some embodiments, adaptation may be performed on the residue signal to adjust the level and/or timbre of the residue signal to match that of the binaural audio signal, thereby causing the audio content from the first audio capture device and the second audio capture device to perceptually match when mixed. In some embodiments, the residue signal may be decorrelated into two decorrelated residue signals that are then mixed with the enhanced binaural audio signal.

At 714, process 700 can generate an output audio signal based on the enhanced binaural audio signal. For example, in an instance in which the residue signal is not processed at block 710, process 700 can transform the enhanced binaural audio signal generated at block 708 to the time domain to generate the output audio signal. Conversely, in an instance in which the residue signal is processed at block 710, process 700 can transform the mix of the residue signal and the enhanced binaural audio signal to the time domain to generate the output audio signal.

The output audio signal may be stored on the first audio capture device and/or the second audio capture device, transmitted to a cloud or server for storage, transmitted to another user device for rendering and/or playback, or the like.

In some embodiments, a rendering device may render an enhanced binaural audio signal based on spatial metadata generated in association with generation of a spatial enhancement mask. The spatial metadata may be used by the rendering device to render the enhanced binaural audio signal based on the head orientation of a listener of the rendering device. For example, the spatial metadata may be used to apply the spatial enhancement mask based on the head orientation and/or mix the binaural audio signal and the residue signal based on the head orientation. In some embodiments, head orientation may be determined by the rendering device based on one or more sensors disposed in or on headphones or earbuds associated with the rendering device.

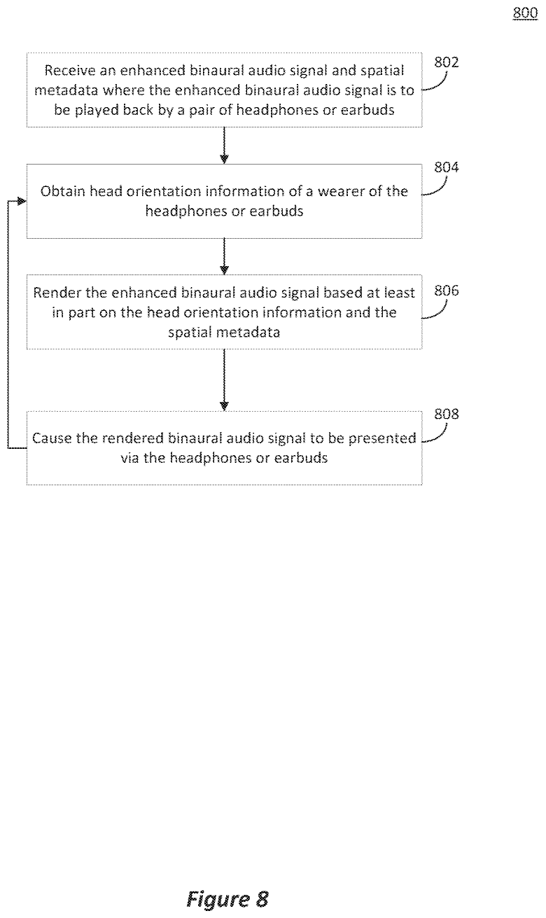

FIG. 8 is flowchart of an example process 800 for rendering an enhanced binaural audio signal in accordance with some embodiments. In some implementations, blocks of process 800 may be executed by one or more processors and/or one or more control systems of the rendering device. An example of such a control system is shown in and described below in connection with FIG. 10. In some embodiments, blocks of process 800 may be executed in an order other than what is shown in FIG. 8. In some embodiments, two or more blocks of process 800 may be executed substantially in parallel. In some embodiments, one or more blocks of process 800 may be omitted.

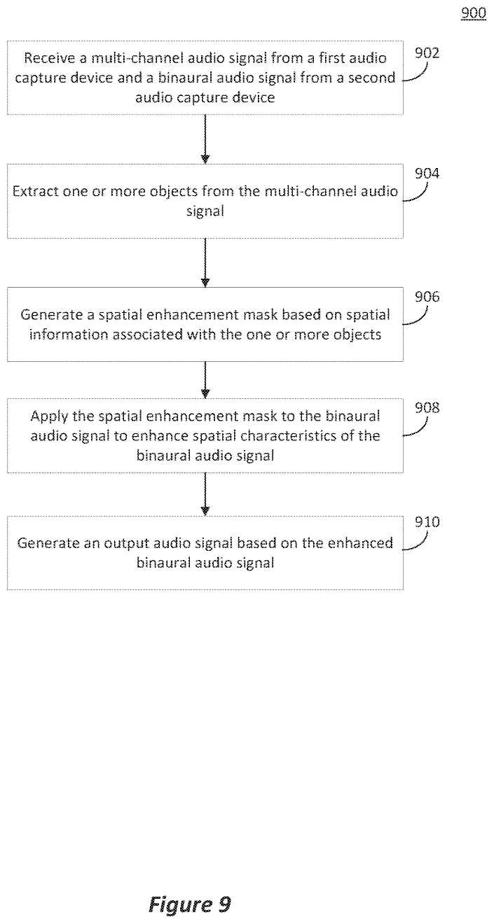

Process 800 can begin at 802 by receiving an enhanced binaural audio signal and spatial metadata, where the enhanced binaural audio signal is to be played back by a pair of headphones or earbuds associated with the rendering device. The binaural audio signal and the spatial metadata may have been generated using, e.g., the techniques shown in and described above in connection with FIG. 7 and/or those shown in and described below in connection with FIG. 9. The enhanced binaural audio signal and the spatial metadata may have been obtained directly from a user device that captured the multi-channel audio content used to generate the enhanced binaural audio signal, from a server that stores the enhanced binaural audio signal, or the like.

At 804, process 800 can obtain head orientation information of a wearer of the headphones or earbuds. The head orientation information may be obtained based on sensor data from one or more sensors. The one or more sensors may include one or more accelerometers, one or more gyroscopes, one or more magnetometers, or the like. The one or more sensors may be disposed in or on the headphones or earbuds. The head orientation may be determined based on the sensor data by the rendering device.

At 806, process 800 can render the enhanced binaural audio signal based at least in part on the head orientation information and the spatial metadata. For example, in some embodiments, process 800 can use the head orientation information and the spatial metadata to cause audio objects to be boosted or attenuated based on the head orientation information and the spatial metadata. By way of example, in an instance in which the enhanced binaural audio signal includes an audio object corresponding to an overhead object (e.g., an airplane flying overhead), process 800 may cause the audio object to be boosted in loudness responsive to the head orientation information indicating the user has rotated their head to look up, or attenuate the audio object responsive to the head orientation information indicating the user is looking down. Example techniques for rendering the enhanced binaural audio signal based on the head orientation information are shown in and described above in connection with FIGS. 5 and 6B.

At 808, process 800 can cause the rendered binaural audio signal to be presented via the headphones or earbuds. Process 800 can then loop back to block 804 and can obtain updated head orientation information to render the next block or portion of the enhanced binaural audio signal. Note that, in some embodiments, process 800 may lop back to block 802 to obtain a next portion of the enhanced binaural audio signal and corresponding spatial metadata, e.g., in instances in which the rendering device is streaming the enhanced binaural audio signal.

FIG. 9 is a flowchart of an example process 900 for generating an enhanced output audio signal based on audio content obtained from two different devices. In some embodiments, blocks of process 900 may be executed on a device that captures user-generated content (e.g., a mobile device, such as a mobile phone or a tablet computer), a desktop computer, a server device that stores and/or provides user-generated content, or the like. In some embodiments, blocks of process 900 may be executed by one or more processors or control systems of such a device, such as control system 1010 of FIG. 10. In some embodiments, blocks of process 900 may be performed in an order other than what is shown in FIG. 9. In some implementations, two or more blocks of process 900 may be performed substantially in parallel. In some implementations, one or more blocks of process 900 may be omitted.

Process 900 can begin at 902 by receiving a multi-channel audio signal from a first audio capture device and a binaural audio signal from a second audio capture device. As described above in connection with FIG. 1, the first audio capture device may be a mobile phone, a tablet computer, smart glasses, etc. The first audio capture device may concurrently capture video content associated with the multi-channel audio content. The second audio capture device may be, e.g., earbuds, paired with the first audio capture device.

At 904, process 900 can extract one or more audio objects from the multi-channel audio signal. Note that, in some embodiments prior to extracting the one or more audio objects, process 900 can transform a time-domain representation of the multi-channel audio signal to a frequency domain representation. In some embodiments, audio object identification may be performed using a trained machine learning model (e.g., a CNN, an RNN, etc.). Additionally or alternatively, in some embodiments, identification of the one or more audio objects may be performed using digital signal processing (DSP) techniques, such as correlation of the multi-channel audio signal across different frequency bands.

At 906, process 900 can generate a spatial enhancement mask based on spatial information associated with the one or more audio objects. For example, the spatial enhancement mask may be determined by applying beamforming techniques to emphasize portions of the multi-channel audio signal originating from one or more spatial directions. For example, the beamforming techniques may emphasize portions of the multi-channel audio signal originating from along the Z axis and may de-emphasize signal originating from the horizontal plane. Example techniques for generating a spatial enhancement mask are shown in and described above in connection with FIG. 3. Note that, in some embodiments, process 900 may additionally generate spatial metadata that may be used by a rendering device to render the enhanced binaural audio signal. For example, the spatial metadata may be used to render the enhanced binaural audio signal based on a head orientation of a listener of the rendering device.

At 908, process 900 can apply the spatial enhancement mask to the binaural audio signal to enhance spatial characteristics of the binaural audio signal. In other words, process 900 can utilize the audio objects identified in the multi-channel audio signal captured by the first audio capture device to emphasize or enhance portions of the binaural audio signal captured by the second audio capture device. Application of the spatial enhancement mask to the binaural audio signal may involve boosting the level of portions of the binaural audio signal (e.g., those corresponding to the identified audio objects) and/or modifying a timbre of portions of the binaural audio signal to emphasize binaural cues. Example techniques for applying a spatial enhancement mask are shown in and described above in connection with FIGS. 4 and 5.

At 910, process 900 can generate an output audio signal based on the enhanced binaural audio signal. For example, process 900 can transform the enhanced binaural audio signal generated at block 908 to the time domain to generate the output audio signal. The output audio signal may be stored on the first audio capture device and/or the second audio capture device, transmitted to a cloud or server for storage, transmitted to another user device for rendering and/or playback, or the like.

FIG. 10 is a block diagram that shows examples of components of an apparatus capable of implementing various aspects of this disclosure. As with other figures provided herein, the types and numbers of elements shown in FIG. 10 are merely provided by way of example. Other implementations may include more, fewer and/or different types and numbers of elements. According to some examples, the apparatus 1000 may be configured for performing at least some of the methods disclosed herein. In some implementations, the apparatus 1000 may be, or may include, a television, one or more components of an audio system, a mobile device (such as a cellular telephone), a laptop computer, a tablet device, a smart speaker, or another type of device.

According to some alternative implementations the apparatus 1000 may be, or may include, a server. In some such examples, the apparatus 1000 may be, or may include, an encoder. Accordingly, in some instances the apparatus 1000 may be a device that is configured for use within an audio environment, such as a home audio environment, whereas in other instances the apparatus 1000 may be a device that is configured for use in “the cloud,” e.g., a server.

In this example, the apparatus 1000 includes an interface system 1005 and a control system 1010. The interface system 1005 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 1005 may, in some implementations, be configured for exchanging control information and associated data with audio devices of the audio environment. The control information and associated data may, in some examples, pertain to one or more software applications that the apparatus 1000 is executing.

The interface system 1005 may, in some implementations, be configured for receiving, or for providing, a content stream. The content stream may include audio data. The audio data may include, but may not be limited to, audio signals. In some instances, the audio data may include spatial data, such as channel data and/or spatial metadata. In some examples, the content stream may include video data and audio data corresponding to the video data.

The interface system 1005 may include one or more network interfaces and/or one or more external device interfaces (such as one or more universal serial bus (USB) interfaces). According to some implementations, the interface system 1005 may include one or more wireless interfaces. The interface system 1005 may include one or more devices for implementing a user interface, such as one or more microphones, one or more speakers, a display system, a touch sensor system and/or a gesture sensor system. In some examples, the interface system 1005 may include one or more interfaces between the control system 1010 and a memory system, such as the optional memory system 1015 shown in FIG. 10. However, the control system 1010 may include a memory system in some instances. The interface system 1005 may, in some implementations, be configured for receiving input from one or more microphones in an environment.

The control system 1010 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 1010 may reside in more than one device. For example, in some implementations a portion of the control system 1010 may reside in a device within one of the environments depicted herein and another portion of the control system 1010 may reside in a device that is outside the environment, such as a server, a mobile device (e.g., a smartphone or a tablet computer), etc. In other examples, a portion of the control system 1010 may reside in a device within one environment and another portion of the control system 1010 may reside in one or more other devices of the environment. For example, a portion of the control system 1010 may reside in a device that is implementing a cloud-based service, such as a server, and another portion of the control system 1010 may reside in another device that is implementing the cloud-based service, such as another server, a memory device, etc. The interface system 1005 also may, in some examples, reside in more than one device. In some implementations, a portion of a control system may reside in or on an earbud.

In some implementations, the control system 1010 may be configured for performing, at least in part, the methods disclosed herein. According to some examples, the control system 1010 may be configured for implementing methods of identifying audio objects in a multi-channel audio signal, generating a spatial enhancement mask based on the identified audio objects, applying the spatial enhancement mask to a binaural audio signal to generate an enhanced binaural audio signal, generating an output signal based on the enhanced binaural audio signal, or the like.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 1015 shown in FIG. 10 and/or in the control system 1010. Accordingly, various innovative aspects of the subject matter described in this disclosure can be implemented in one or more non-transitory media having software stored thereon. The software may, for example, extract objects from a multi-channel audio signal, generate a spatial enhancement mask, apply a spatial enhancement mask, generate an output binaural audio signal, or the like. The software may, for example, be executable by one or more components of a control system such as the control system 1010 of FIG. 10.

In some examples, the apparatus 1000 may include the optional microphone system 1020 shown in FIG. 10. The optional microphone system 1020 may include one or more microphones. In some implementations, one or more of the microphones may be part of, or associated with, another device, such as a speaker of the speaker system, a smart audio device, etc. In some examples, the apparatus 1000 may not include a microphone system 1020. However, in some such implementations the apparatus 1000 may nonetheless be configured to receive microphone data for one or more microphones in an audio environment via the interface system 1010. In some such implementations, a cloud-based implementation of the apparatus 1000 may be configured to receive microphone data, or a noise metric corresponding at least in part to the microphone data, from one or more microphones in an audio environment via the interface system 1010.

According to some implementations, the apparatus 1000 may include the optional loudspeaker system 1025 shown in FIG. 10. The optional loudspeaker system 1025 may include one or more loudspeakers, which also may be referred to herein as “speakers” or, more generally, as “audio reproduction transducers.” In some examples (e.g., cloud-based implementations), the apparatus 1000 may not include a loudspeaker system 1025. In some implementations, the apparatus 1000 may include headphones. Headphones may be connected or coupled to the apparatus 1000 via a headphone jack or via a wireless connection (e.g., BLUETOOTH).

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

1. A method for enhancing audio content, the method comprising:
receiving a multi-channel audio signal from a first audio capture device and a binaural audio signal from a second audio capture device;
extracting one or more objects from the multi-channel audio signal;
generating a spatial enhancement mask based on spatial information associated with the one or more objects;
applying the spatial enhancement mask to the binaural audio signal to enhance spatial characteristics of the binaural audio signal to generate an enhanced binaural audio signal; and
generating output binaural audio signal based on the enhanced binaural audio signal.

2. The method of claim 0, further comprising processing a residue associated with the multi-channel audio signal, wherein the residue comprises portions of the multi-channel audio signal other than those associated with the one or more objects.

3. The method of claim 0, wherein processing the residue comprises emphasizing portions of the residue originating from at least one spatial direction.

4. The method of claim 0, wherein the at least one spatial direction comprises an up-and-down direction.

5. The method of claim 2, further comprising mixing the processed residue with the enhanced binaural audio signal prior to generating the output binaural audio signal.

6. The method of claim 1, wherein generating the spatial enhancement mask comprises generating gains to be applied to the one or more objects from the multi-channel audio signal based on spatial directions associated with the one or more objects.

7. The method of claim 1, further comprising applying at least one of: a) level adjustments; or b) timbre adjustments to the binaural audio signal.

8. The method of claim 0, wherein the level adjustments are configured to boost a level associated with less prominent objects of the one or more objects compared to more prominent objects of the one or more objects.

9. The method of claim 7, wherein the timbre adjustments are configured to account for a head-related transfer function that provides binaural cues to a listener.

10. The method of any one of claim 1, further comprising storing the generated output binaural audio signal in connection with spatial metadata associated with the extracted one or more objects.

11. The method of claim 0, wherein the spatial metadata is usable by a playback device to render the generated output binaural audio signal based on head tracking information.

12. The method of claim 1, wherein extracting the one or more objects comprises at least one of: using a trained machine learning model; or using a correlation-based analysis.

13. The method of any claim 1, wherein the one or more objects comprise at least one speech object and at least one non-speech object.

14. The method of claim 1, wherein at least one of the first audio capture device or the second audio capture device is a mobile phone.

15. The method of claim 1, wherein at least one of the first audio capture device or the second audio capture device is a wearable device.

16. The method of claim 1, wherein the multi-channel audio signal is captured in connection with video content captured by the first audio capture device.

17. The method of claim 1, further comprising transforming the multi-channel audio signal and the binaural audio signal from a time domain representation to a frequency domain representation prior to extracting the one or more objects from the multi-channel audio signal.

18. The method of claim 0, wherein generating the output binaural audio signal based on the enhanced binaural audio signal comprises transforming the enhanced binaural audio signal from a frequency domain representation to a time domain representation.

19. A method of presenting audio content, the method comprising:
receiving an enhanced binaural audio signal and spatial metadata to be played back by a pair of headphones or earbuds, wherein the enhanced binaural audio signal was generated based on audio content captured by two different audio capture devices, and wherein the spatial metadata was generated based on audio objects extracted in audio content captured by at least one of the two different audio capture devices;
obtaining head orientation information of a wearer of the headphones or earbuds;
rendering the enhanced binaural audio signal based at least in part on the head orientation information and the spatial metadata; and
causing the rendered enhanced binaural audio signal to be presented via the headphones or the earbuds.

20. A system comprising:
a processor; and
a computer-readable medium storing instructions that, upon execution by the processor, cause the processor to perform operations of claim 1.

21. A computer-readable medium storing instructions that, upon execution by a processor, causes the processor to perform operations of claim 1.
